(19) United States
(12) Patent Application Publication
(10) Pub. No.: US 2025/0103943 A1
(43) Pub. Date: Mar. 27, 2025

(54) RETRIEVAL STRATEGY SELECTION OPTIMIZATION USING REINFORCEMENT LEARNING

(71) Applicant: Roku, Inc., San Jose, CA (US)

(72) Inventors: Yuxi Liu, Mountain View, CA (US); Abhishek Majumdar, Santa Clara, CA (US); Nitish Aggarwal, Sunnyvale, CA (US)

(73) Assignee: Roku, Inc., San Jose, CA (US)

(21) Appl. No.: 18/423,834

(22) Filed: Jan. 26, 2024

Related U.S. Application Data
(60) Provisional application No. 63/584,359, filed on Sep. 21, 2023.

(51) Int. Cl. G06N 20/00

(52) U.S. Cl. CPC G06N 20/00

(57) ABSTRACT

Retrieving content items in response to a query in a way that increases user satisfaction and increases chances of users consuming a retrieved content item is not trivial. One content item retrieval system can combine different retrieval strategies. The content item retrieval system can retrieve a number of content items using different retrieval strategies and combining the content items together as the final results of the search. A naïve approach is to show fixed numbers of content items retrieved using the different retrieval strategies for any query. User engagement can be improved if the numbers can be tuned or optimized for a given query. Reinforcement learning can be used to train and implement an agent model that can choose the optimal numbers of content items retrieved using different retrieval strategies for a given query.

### CROSS-REFERENCE TO RELATED APPLICATIONS

This non-provisional application claims priority to and/or receives benefit from provisional application, titled “RETRIEVAL STRATEGY SELECTION OPTIMIZATION USING REINFORCEMENT LEARNING”, Ser. No. 63/584,359, filed on Sep. 21, 2023. The provisional application is hereby incorporated by reference in its entirety.

### TECHNICAL FIELD

This disclosure relates generally to reinforcement learning, and more specifically, using reinforcement learning to optimize retrieval strategy selection.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates content item retrieval using different retrieval strategies, according to some embodiments of the disclosure.

FIG. 2A-B illustrate using reinforcement learning to obtain an agent model that can output optimized weights corresponding to different content retrieval strategies, according to some embodiments of the disclosure.

FIG. 3 illustrates exemplary world parameters, according to some embodiments of the disclosure.

FIG. 4 illustrates exemplary agent model flow, according to some embodiments of the disclosure.

FIG. 5 is a flow chart illustrating operations performed in a round of an episode, according to some embodiments of the disclosure.

FIG. 6 is a flowchart illustrating operations for training and/or updating an agent model using round results, according to some embodiments of the disclosure.

FIG. 7 is a flowchart showing a method for training and/or updating parameters of an agent model, according to some embodiments of the disclosure.

FIG. 8 is a block diagram of an exemplary computing device, according to some embodiments of the disclosure.

### DETAILED DESCRIPTION

### Overview

Content platforms offer users access to large libraries of content items. Users can spend a lot of time on a content platform to look for content items to consume. Finding the content items that a user is looking for can be important for user satisfaction. If a user is not satisfied, the user is likely not going to return to the content platform. Also, if a user is not satisfied, the user is likely not going to consume any content items.

Retrieving content items in response to a query in a way that increases user satisfaction and increases chances of users consuming a retrieved content item is not trivial. A query may include a natural language description of what a user is searching for or looking for in a library of content items.

One content item retrieval system can combine different retrieval strategies. The content item retrieval system can retrieve a number of content items using different retrieval strategies and combining the content items together as the final results of the search. A naïve approach is to show fixed numbers of content items retrieved using the different retrieval strategies for any query. For example, one approach is to show 10 content items retrieved using each retrieval strategy.

User engagement can be improved if the numbers can be tuned or optimized for a given query. Reinforcement learning can be used to train and implement an agent model that can choose the optimal numbers of content items retrieved using different retrieval strategies for a given query.

In some cases, user engagement can be improved if the numbers can be tuned or optimized for additional contextual factor(s) in addition to the query. The query and one or more contextual factors together can form a context for content item retrieval.

Reinforcement learning can be beneficial because the technique does not require a large set of high quality prior labeled data. Instead, an agent model can complete rounds and episodes in a simulated environment. In some cases, an agent model can also learn from real users completing rounds and episodes. Rounds and episodes can explore the simulated environment to discover patterns and/or trends and does not depend on supervised training data. The rounds and episodes can be used to train the agent model to optimize for an action with the highest long-term reward for a given query.

The described reinforcement technique has unique features relating to the simulated environment (also referred herein as the world parameters), design of the rounds and episodes, the agent model (including the action the agent model takes), and design of rewards. Herein, an episode may include one or more rounds. The unique features are implemented for determining and optimizing N's for different retrieval strategies for a given context comprising a query. The unique features can choose N's that optimizes long-term reward and success with users long-term.

Challenges with Semantic Search in a Content Retrieval System

Content providers may manage and allow users to access and view thousands to millions or more content items. Content items may include media content, such as audio content, video content, image content, augmented reality content, virtual reality content, mixed reality content, game, textual content, interactive content, etc. Finding exactly what a user is looking for, or finding what the user may find most relevant can greatly improve the user experience. In some cases, a user may provide voice-based or text-based queries to find content items. Examples of queries may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?” and
“I want to see a film set in Tuscany but is not dubbed in English.”

Different retrieval strategies may be available for retrieving content items in response to a query.

One example of a retrieval strategy is lexical match. In lexical match search, the query may be processed to extract keywords, and the keywords may be lexicographically matched against a database of content items and associated keywords. Content items which may have the most number of keyword lexicographic matches may be returned in response to the query.

Another example of a retrieval strategy is semantic retrieval. Semantic retrieval may utilize a model to interpret the semantic meaning or context of a query and find content items that may match with the query. A model may implement natural language processing to interpret the query. A model may involve neural networks (e.g., transformer-based neural networks). A model may include a large language model (LLM).

Yet another example of a retrieval strategy is graph embedding based approach to content item retrieval. A graph embedding based approach may find a subgraph of a graph of content items which may be engaging to the user for a given query. In some cases, the graph may model relationships between content items. In some cases, the graph embedding based approach may utilize the graph to identify content items which may not be directly connected to an initial set of content items that matches the query.

Yet another example of a retrieval strategy may involve returning a fixed set or list of results for a particular query. The set or list of results may be curated by editor(s), hardcoded, or predetermined. For example, a query for “presidential debate” may retrieve predetermined content items which are tapings of the most recent presidential debates, and not content items related to presidential inaugurations or state of the union addresses.

Yet another example of a retrieval strategy may involve searching for content items based on user query history and/or user interactivity history information. For example, content items may be retrieved based on whether the user has launched a particular content item in the past.

Yet another example of a retrieval strategy may involve searching for content items based on user profile or user characteristic(s). For example, content items may be retrieved based on demographic information about the user.

Yet another example of a retrieval strategy may involve collaborative filtering. Content items may be retrieved based on interactivity with the content platform and characteristics about various users on the system. For example, content items may be retrieved based on content items viewed by users who may be similar to the current user making the query. Users may be similar to the current user if the users behaved similarly on the content platform. Users may be similar to the current user if the users are socially connected with the current user.

Yet another example of a retrieval strategy may involve returning a number of content items from each clusters or buckets of content items. For example, content items may be clustered based on type or verticals (e.g., music, book, short videos, long videos, audio-only, live content, games, etc.), and a certain number of content items from each type may be returned as retrieved content items to diversify the types of content items being retrieved. The retrieved content items may have a balance of different types of content items.

User experience and engagement with retrieval of content items in response to a query can depend on whether the content item retrieval system can retrieve content items that the user is looking for in the query. Some retrieval strategies may be more suitable or better at finding content items that are most engaging to the user for the given query. However, it is a challenge to determine which retrieval strategy is better for a given query without prior labeled data.

### Utilizing a Combination of Retrieval Strategies

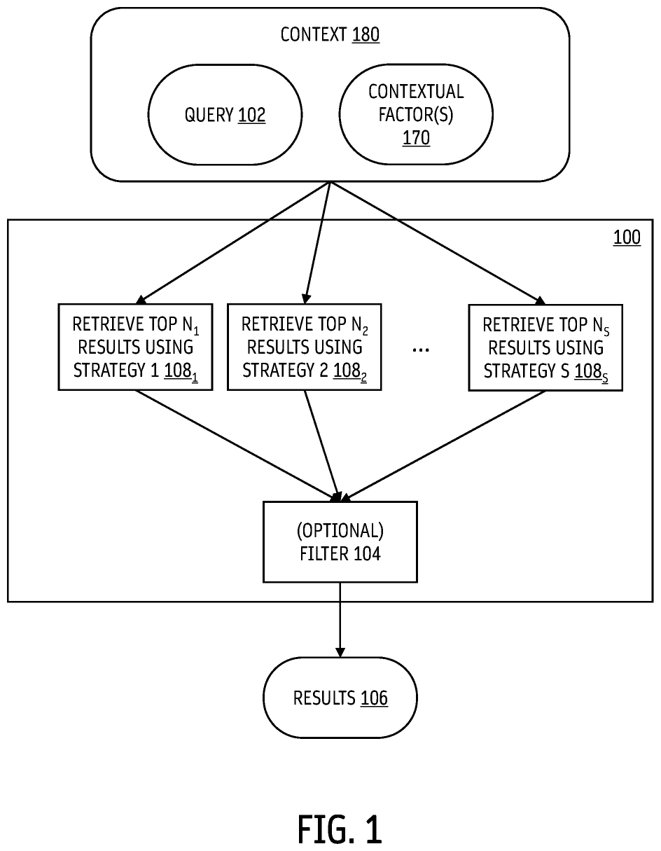

In some cases, a user may find retrieved content items more useful when multiple retrieval strategies are used to retrieve a set of content items. FIG. 1 illustrates content item retrieval using different retrieval strategies, according to some embodiments of the disclosure. A user may provide a context 180. Context 180 may include query 102. Context 180 may include one or more contextual factors 170. Examples of contextual factors 170 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, etc.

Context 180, including query 102 and optionally one or more contextual factors 170, may be applied to retrieve content items using different retrieval strategies in technique 100 to generate results 106. Results 106 may include retrieved content items for query 102. Technique 100 may include S number of (parallel) operations to retrieve top Nₛ results using S different retrieval strategies. Exemplary operations are shown as retrieve top N₁ results using strategy 1 108₁, retrieve top N₂ results using strategy 2 108₂, . . . and retrieve top Nₛ results from bucket S 108_{S}. The S different retrieval strategies are different from each other. S different retrieval strategies may include two or more of: lexical match, semantic retrieval, graph embedding based approach, retrieval strategy described herein, etc. Retrieved content items using different retrieval strategies may be different from each other. Retrieved content items using different retrieval strategies may have some overlap.

In some cases, filter 104 may remove duplicate content items in the collection of top Nₛ results from the S operations in technique 100. In some cases, filter 104 may optionally filter out or remove a number of content items from the collection of top Nₛ results from S operations. Filter 104 may trim down the collection before outputting the retrieved content items as results 106. Filter 104 may compute and/or determine one or more metrics for each one of top Nₛ results from the S operations. Filter 104 may filter out a number of content items having one or more metrics that do not meet one or more criteria. Filter 104 may keep a number of content items having one or more metrics that meet one or more criteria.

### Optimizing N's for Different Retrieval Strategies Using Reinforcement Learning

In some cases, the N's may be fixed and does not change for a given context, such as a query. In some cases, the N's may be the same across the different retrieval strategies and does not change for a given context. For certain contexts, changing the N's based on the given context can improve the user engagement because having more retrieved content items using a particular retrieval strategy than another retrieval strategy may respond to the context better. For example, if the query in the context includes very specific keywords, returning more content items retrieved using lexical match than content items retrieved using semantic retrieval may be more useful to the user. In another example, if the query in the context is vague and does not provide many keywords, returning more content items retrieved using semantic retrieval than content items retrieved using lexical match may be more useful to the user. In yet another example, the one or more contextual factors in the context may impact whether content items retrieved using a particular retrieval strategy may be more relevant than content items retrieved using a different retrieval strategy. Without prior labeled training data, it can be a challenge to determine optimal N's for content item retrieval using different retrieval strategies for a given context.

In some cases, Nₛ for a given retrieval strategy may be represented by a percentage, weight, or proportion of a number of content items to be retrieved using the retrieval strategy relative to a total number of content items to be returned to the user for a given query.

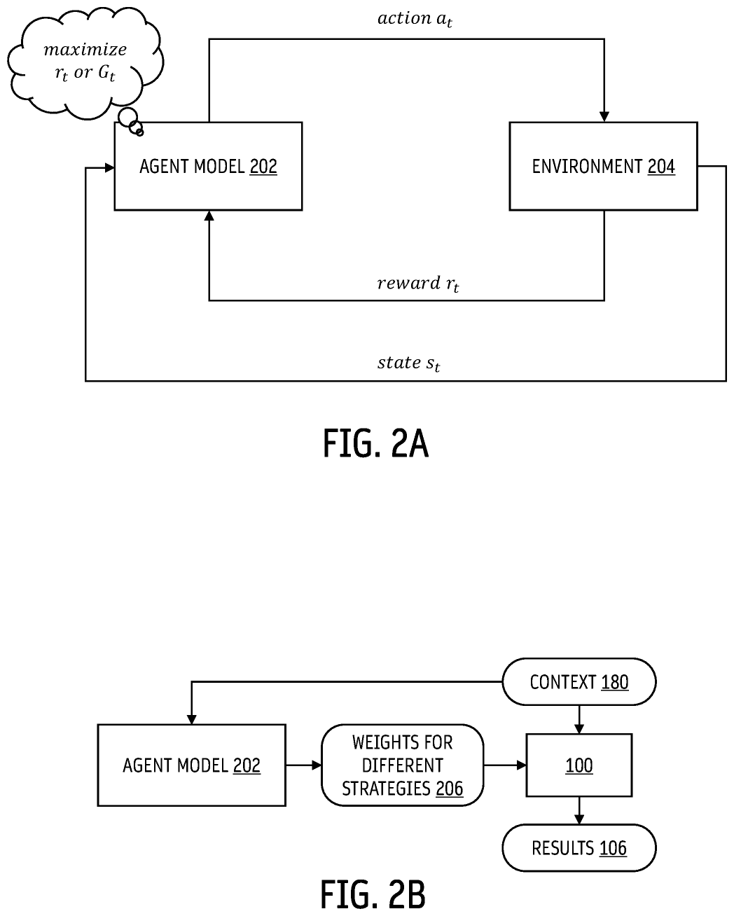

FIGS. 2A-B illustrate using reinforcement learning to obtain an agent model 202 that can output optimal weights 206 corresponding to different content retrieval strategies, according to some embodiments of the disclosure. FIG. 2A illustrates a reinforcement learning system, which can include an agent model 202 and an environment 204. FIG. 2B illustrates an exemplary content item retrieval system, which includes context 180, technique 100, and results 106. Agent model 202 trained using reinforcement learning system in FIG. 2A can be used in the content item retrieval system in FIG. 2B. Agent model 202 may include a model that can determine (optimal) weights 206 corresponding to different retrieval strategies for a given context 180, where the weights 206 can be used in a content item retrieval system (e.g., a search and recommendation system). Weights 206 generated by agent model 202 based on context 180 may be used to determine the Nₛ used in technique 100. Weights 206 may be used to determine the numbers of content items to retrieve using different retrieval strategies to return by technique 100 as results 106.

Referring back to FIG. 2A, agent model 202 may be given a version of the environment 204 as determined by state sₜ. Based on the knowledge of agent model 202 and a current strategy (e.g., a current policy or current parameters of the agent model 202), agent model 202 can take an action aₜ. Taking an action aₜ may allow agent model 202 to explore for new opportunities or exploit new behaviors. On the basis of the action aₜ, the environment 204 may give a reward rₜ. The reward rₜ can be determined based on world parameters of environment 204 (e.g., indicators of positive and negative interactions). The reward can be used to update a new observed state, e.g., state sₜ₊₁. The reward can be used to update the strategy (e.g., policy or parameters) of agent model 202 based on how well or poorly agent model 202 performed in the exploration. The agent model 202 may maximize round rewards rₜ and/or expected long-term rewards Gₜ:

$${G}_{t} = {r}_{t + 1} + γ {r}_{t + 2} + {γ}^{2} {r}_{t + 3} + … = {\sum }_{j = 0}^{T} {γ}^{j} {r}_{t + j + 1}$$

Round rewards rₜ may include a reward for a given round (e.g., measuring instantaneous or immediate reward). Reinforcement learning optimizing rₜ can learn to maximize instant rewards. Expected long-term rewards Gₜ may include a weighted sum of round rewards rₜ at different rounds of an episode (e.g., an episode may include 10 rounds), including a current round and one or more future/subsequent rounds in an episode. For example, expected long-term reward Gₜ at round 1 of an episode involving 10 rounds may include a weighted sum of round rewards of rₜ for the 10 rounds. Weights are represented as parameter γ, which can be set or adjusted to vary the amount of impact future round rewards rₜ, rₜ₊₁, rₜ₊₂, . . . may have on long-term rewards Gₜ. Gₜ thus not only encompasses the instantaneous and immediate round reward, Gₜ encompasses expected future rewards in an episode of rounds. Reinforcement learning optimizing Gₜ can thus learn to maximize long-term rewards Gₜ and learn the impact of the action aₜ taken by agent model 202 long-term.

Agent model 202 in FIG. 2A may explore the environment 204 over many rounds and episodes. Accordingly, agent model 202 can learn from the exploration based on the reward given by environment 204. Using the reward, the strategy, policy, and parameters of agent model 202 can be trained by the exploration and updated to select N's that maximize round rewards rₜ and/or long-term rewards Gₜ.

The agent model 202 may observe a state sₜ, which may include a context comprising the input query made by a simulated user and optionally one or more contextual factors. The state space may describe the observation the agent model 202 makes, before taking an action aₜ. For semantic retrieval of content items, the state space may include a query embedding generated by a query semantic model using the input query made by the simulated user. In some cases, the state space may include a context embedding generated by a model using the context comprising the input query and one or more contextual factors.

Given the state sₜ, the agent model 202 can take an action aₜ, which can correspond to retrieving content items, based on a context comprising an input query and optionally one or more contextual factors, using different retrieval strategies and giving different weights to the different retrieval strategies (e.g., choosing Nₛ).

The action space may define (all) the possible actions the agent model 202 can take. In some embodiments, content items have corresponding content item feature vectors. A content item feature vector may be a V dimensional vector [F₁, F₂, . . . , and F_{V}], having V content item features. The action space may include a weight vector of the same size as the content item feature vectors, signifying the importance given to each content item feature in a content item feature vector. In particular, a content item feature vector includes one or more features associated with the retrieval strategy used in obtaining a content item. The action of the agent model 202 may include a V dimensional action vector [A₁, A₂, . . . , and A_{V}] indicating the weights and scaling of the content item features in a content item feature vector. In particular, the action vector includes one or more features that correspond to different retrieval strategies, e.g., giving weights to different retrieval strategies. The content item features may be scaled by their corresponding weights in the action vector by performing a dot product of the content item feature vector and the action vector.

In some cases, the dimensionality of the content item feature vector may be the same as the dimensionality of the action vector.

On taking the action aₜ, the environment 204 (e.g., representative of user simulated behaviors), can yield a corresponding reward rₜ and/or Gₜ. Depending on the feedback reward rₜ and/or Gₜ received from environment 204, agent model 202 learns (e.g., updates its policy) and can try again, attempting to get better at performing the action aₜ, for a given state sₜ of the environment 204 (e.g., finding better weights to different retrieval strategies, and thus better N's for a given context comprising a query and optionally one or more contextual factors).

Reinforcement learning illustrated in FIG. 2A can be implemented using one or more approaches to training agent model 202. For example, agent model 202 can learn through batch reinforcement learning. Agent model 202 can learn from a fixed dataset of actual experiences, in some cases, without interacting with environment 204. In another example, agent model 202 can learn through online reinforcement learning. Agent model 202 can learn from interacting with environment 204 in real time. Agent model 202 may be trained using rewards provided by environment 204. In yet another example, agent model 202 can learn through a combination of batch reinforcement learning and online reinforcement learning.

Reinforcement learning illustrated in FIG. 2A can implement Q-learning. In Q-learning, agent model 202 may learn to output action vectors by maximizing an expected reward of an action vector generated based on a given state.

Reinforcement learning illustrated in FIG. 2A can implement temporal difference learning, which may be particularly useful for optimizing agent model 202 to take actions that are temporal in nature (e.g., completing rounds in an episode to optimize long-term expected rewards). In temporal difference learning, agent model 202 may predict a reward in a next moment in time. When a new reward is observed, the new reward can be compared against the predicted/expected reward. If the two rewards differ, the agent model 202 may use the temporal difference to adjust parameters of agent model 202 to better match the new reward.

Referring to FIG. 2B, the action vector output of the agent model 202 after the agent model 202 learns through reinforcement learning as illustrated in FIG. 2A can be used to determine optimal weights 206 for a given context 180. Context 180 of a user making a query may be used as input to agent model 202. Agent model 202 can produce an action vector based on context 180. The action vector can be used to determine optimal weights 206 for different retrieval strategies in technique 100. The context 180 may be provided as input to the different retrieval strategies in technique 100. Optimal weights 206 may be applied to weigh the distribution of retrieved content items across the different retrieval strategies in technique 100. In other words, the optimal weights 206 may determine N's for the context 180, which are used to collate results 106 using appropriate N's for different retrieval strategies. Results 106 may be provided or displayed to the user.

### Exemplary World Parameters of the Environment

As discussed with FIG. 2A, agent model 202 can explore environment 204, and take action to learn how to update the parameters of agent model 202. Agent model 202 can explore environment 204 in the form of many rounds and episodes and learn from the results of the rounds and episodes. Environment 204 may represent real world data and/or simulated data about queries and content items. In some embodiments, environment 204 may represent real world data and/or simulated data about contexts and content items. Environment 204 may include one or more world parameters 302, e.g., variables that define a round (e.g., a simulated version of environment 204). Agent model 202, when exploring environment 204 in a round, can sample from the one or more world parameters 302 to simulate content item retrieval and take an action on the content items retrieved. Agent model 202, when exploring environment 204, can follow one or more rules, e.g., dynamics defining how the variables interact, to carry out one or more rounds to complete an episode. Following the one or more rules over multiple rounds in an episode, agent model 202 can simulate long-term user interaction in content item retrieval when exploring environment 204. Results of rounds and episodes may be observed and used to update parameters of agent model 202.

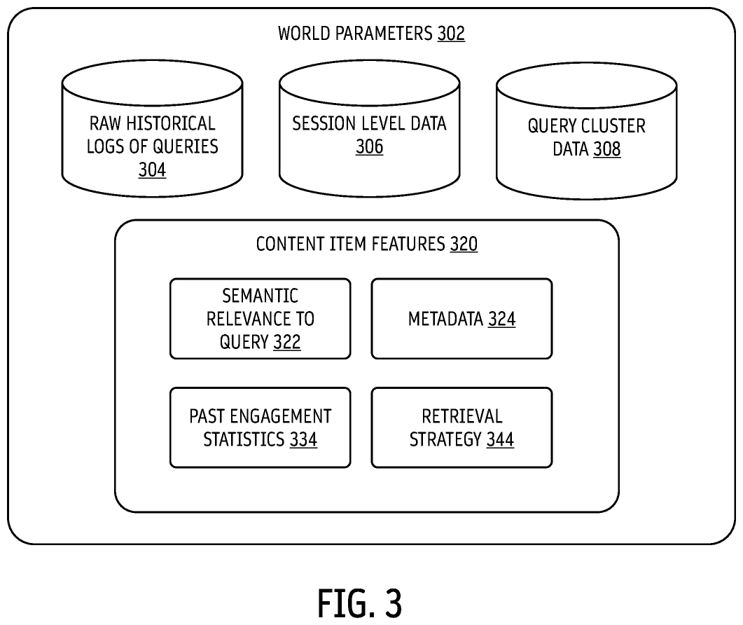

FIG. 3 illustrates exemplary world parameters 302, according to some embodiments of the disclosure. World parameters 302 may include one or more of: raw historical logs of queries 304, session-level data 306, and query cluster data 308. World parameters 302 may include one or more content item features 320, e.g., semantic relevance/affinity to a given query 322, metadata 324, past engagement statistics 334, and retrieval strategy 344. World parameters 302 may offer a representation of an environment from which simulated environments can be pulled.

Raw historical logs of queries 304 that (real world) users have made on a content retrieval system (e.g., a search and recommendation system) may include raw data of queries made by users on the content retrieval system, content items which were shown to a user in a given session for a query, content item(s) which were clicked, and content item(s) which were launched, and which specific retrieval strategy was used to retrieve the content item. Raw historical logs of queries 304 may include session identifiers, timestamps, device identifiers, profile identifiers, query made, whether a content item shown was focused, whether a content item shown was clicked on, whether a content item shown was launched, whether a content item was shown but never focused, clicked on, or launched, streaming duration for a content item, etc. In some cases, raw historical logs of queries 304 includes contextual factor(s) that accompanied the queries made by users. Raw historical logs of queries 304 may be replaced by and/or supplemented with raw historical logs of contexts that includes contexts that (real world) users have provided as input on a content retrieval system. Raw historical logs of contexts can include raw data of queries made by users on the content retrieval system, one or more contextual factors, content items which were shown to a user in a given session for the context, content item(s) which were clicked, and content item(s) which were launched, and which specific retrieval strategy was used to retrieve the content item. Raw historical logs of contexts may include session identifiers, timestamps, device identifiers, profile identifiers, query made, one or more contextual factors, whether a content item shown was focused, whether a content item shown was clicked on, whether a content item shown was launched, whether a content item was shown but never focused, clicked on, or launched, streaming duration for a content item, etc.

Session-level data 306 may be derived from raw historical logs of queries 304. Session-level data 306 may provide user-level or session-level representation of the environment. Session-level data 306 may include many log entries or rows. Session-level data 306 may include user distinct session-level data. Session-level data 306 may include queries made on the content item retrieval system and interaction data with content items (e.g., whether a content item was clicked, launched, or skipped for a given query). A log entry or row in session-level data 306 may include a session identifier that identifies a user session on the content item retrieval system in which a query was made. The log entry or row in session-level data 306 may include a query (e.g., a string value) that identifies the free language query that a user made on the content item retrieval system in the session. The log entry or row in session-level data 306 may include one or more launched content item identifiers (e.g., an array of one or more content item identifiers) specifying one or more content items that were launched in the session for the query. The log entry or row in session-level data 306 may include one or more clicked content item identifiers (e.g., an array of one or more content item identifiers) specifying one or more content items that were clicked in the session for the query. A content item in the one or more launched content item identifiers may not be double counted in the one or more clicked content item identifiers for a given session. A content item may be in the one or more clicked content item identifiers and not in the one or more launched content item identifiers if the content item was clicked but not launched in the given session. A log entry or row in session-level data 306 may include an identifier identifying the specific retrieval strategy used to retrieve a particular content item in response to the query. In some embodiments, session-level data 306 may be derived from raw historical logs of contexts. The log entry or row in session-level data 306 may include one or more contextual factors.

Query cluster data 308 may be derived from raw historical logs of queries 304. Similar or same queries that are semantically similar or same can be grouped into query clusters to group data to provide an aggregate-level representation of the environment. For example, a query “show me western movies”, a query “western movies”, and a query “play western movies” can be grouped or clustered together. Queries in raw historical logs of queries 304 may be analyzed to determine query clusters having semantically similar or same queries. A log entry or row in query cluster data 308 may include one or more launched content items (e.g., an array of one or more content item identifiers) specifying one or more content items that were launched for the query cluster. A log entry or row in query cluster data 308 may include one or more click-bait content items (e.g., an array of one or more content item identifiers) specifying one or more content items that were clicked but not launched for the query cluster. A log entry or row in query cluster data 308 may include one or more skipped content items (e.g., an array of one or more content item identifiers) specifying one or more content items that were shown to users but not clicked nor launched for the query cluster. One or more skipped content items may represent true negatives because users never engaged with the items for a given query or query cluster. A log entry or row in query cluster data 308 may include an identifier identifying the specific retrieval strategy used to retrieve a particular content item in response to the query. In some cases, query cluster data 308 may be replaced by and/or supplemented with context cluster data. Similar or same contexts may be grouped into context clusters to provide an aggregate-level representation of the environment.

When an agent plays a round, content items that are sampled from the environment for the round may have content item features 320. Content item features 320 may be represented as a content item feature vector for a content item. Content item features 320 may be generated from one or more of: description about a content item, metadata about a content item, past engagement statistics, and retrieval strategy that was used to retrieve the content item. A content item feature vector may be generated using a suitable model (e.g., a neural network) based on one or more parts of content item features 320. In an example, content item feature vector may be generated based on one or more of: a description of the content item, metadata about the content item, past engagement statistics of the content item, and retrieval strategy used to retrieve the content item.

One example of a content item feature is the semantic relevance/affinity to a given query 322. Semantic relevance/affinity may be determined based on a dot product between a query embedding of the given query using a language model and content item features extracted from a description about the content item (e.g., synopsis, plot description, summary, script, etc.) using the language model. Semantic relevance/affinity (score) may measure the semantic relevance of a content item to a given query. In some cases, the semantic relevance/affinity to a given query 322 may be replaced by and/or supplemented with contextual relevance/affinity to a given context comprising a query and one or more contextual factors. Contextual relevance/affinity may be determined based on a dot product between a context embedding of the given context using a model and content item features extracted from a description about the content item (e.g., synopsis, plot description, summary, script, etc.) using the same model. The contextual relevance/affinity (score) may measure the contextual relevance of a content item to a given context.

Another example of a content item feature is the metadata 324 about a content item. Metadata can include data or tags for the content item, such as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, etc.

Yet another example of a content item feature is past engagement statistics 334 about a content item. Past engagement statistics may capture popularity, trends, performance, and/or interactions with the content item. Examples of past engagement statistics may include: number of clicks of the content item in the past A number of days, number of launches of the content item in the past B number of days, click-through rate, launch rate, streaming hours in the past C number of days, number of long watches, amount of revenue generated, etc.

Yet another example of a content item feature is retrieval strategy 344. Retrieval strategy information may capture and/or identify which retrieval strategy (out of different retrieval strategies) was used to retrieve a particular content item during a user session.

Yet another example of a content item feature includes a combination and/or interaction(s) between two or more of: semantic relevance/affinity to a given query 322, metadata 324, past engagement statistics 334, and retrieval strategy 344.

### Exemplary Agent Model Flow

In reinforcement learning, an agent model explores the environment to learn from the exploration and observations made from the exploration. The agent model may play one or more rounds in an episode. Round-level reward can be determined for each round. The agent model may complete one or more episodes. Long-term reward can be determined for each round based on the round-level reward of the present round and one or more future rounds in a given episode.

In some embodiments, the exploration involves creating simulated searches from the environment, and letting a simulated user judge whether the retrieved content items are good or not. The exploration is referred herein as the agent model playing rounds through simulated searches. In a simulated search, the agent model may take an action to retrieve top Q number of items that the agent finds as most relevant to the input query. To simulate a search, the environment, encompassing logs of past queries and interactions with the content items shown to users, is sampled. The logs of interactions may include positive interactions with content items (e.g., content items which were launched). These positive interactions may be considered positive content items for a query. Positive content items may be associated with a positive reward for the agent model. The logs of interactions may include negative interactions with content items (e.g., content items which were never launched, content items which were never focused, clicked on, or launched, etc.). The negative interactions may be considered negative content items for a query. Negative content items may be associated with a negative reward for the agent model.

In some embodiments, in a simulated search, the agent model may take an action to retrieve top Q number of items that the agent finds as most relevant to the input context. To simulate a search, the environment, encompassing logs of past contexts and interactions with the content items shown to users, is sampled. The logs of interactions may include positive interactions with content items (e.g., content items which were launched). These positive interactions may be considered positive content items for the context. Positive content items may be associated with a positive reward for the agent model. The logs of interactions may include negative interactions with content items (e.g., content items which were never launched, content items which were never focused, clicked on, or launched, etc.). The negative interactions may be considered negative content items for the context. Negative content items may be associated with a negative reward for the agent model.

In each simulated search, the environment can provide a query, and the query's corresponding positive content items and negative content items. The query can be randomly drawn from the environment (e.g., historical logs, session-level data, and query cluster data). Content items may be randomly sampled from the query's corresponding positive content items and negative content items. For example, sampled content items may include P items from the query's corresponding positive content items, and N items from the query's corresponding negative content items. The agent model may observe the state constructed by the query, and the content item features (content item feature vectors) of the sampled content items. The agent model can produce an action (e.g., in the form of an action vector) based on its current policy (and parameters) and decide on the top Q content items to return. The environment can evaluate the usefulness/relevancy of the returned content items and circles back a reward signal. The agent model may update its policy (and parameters) based on the reward feedback.

In some embodiments, each simulated search, the environment can provide a context, and the context's corresponding positive content items and negative content items. The context can be randomly drawn from the environment (e.g., historical logs, session-level data, and context cluster data). Content items may be randomly sampled from the context's corresponding positive content items and negative content items. For example, sampled content items may include P items from the context's corresponding positive content items, and N items from the context's corresponding negative content items. The agent model may observe the state constructed by the query, and the content item features (content item feature vectors) of the sampled content items. The agent model can produce an action (e.g., in the form of an action vector) based on its current policy (and parameters) and decide on the top Q content items to return. The environment can evaluate the usefulness/relevancy of the returned content items and circles back a reward signal. The agent model may update its policy (and parameters) based on the reward feedback.

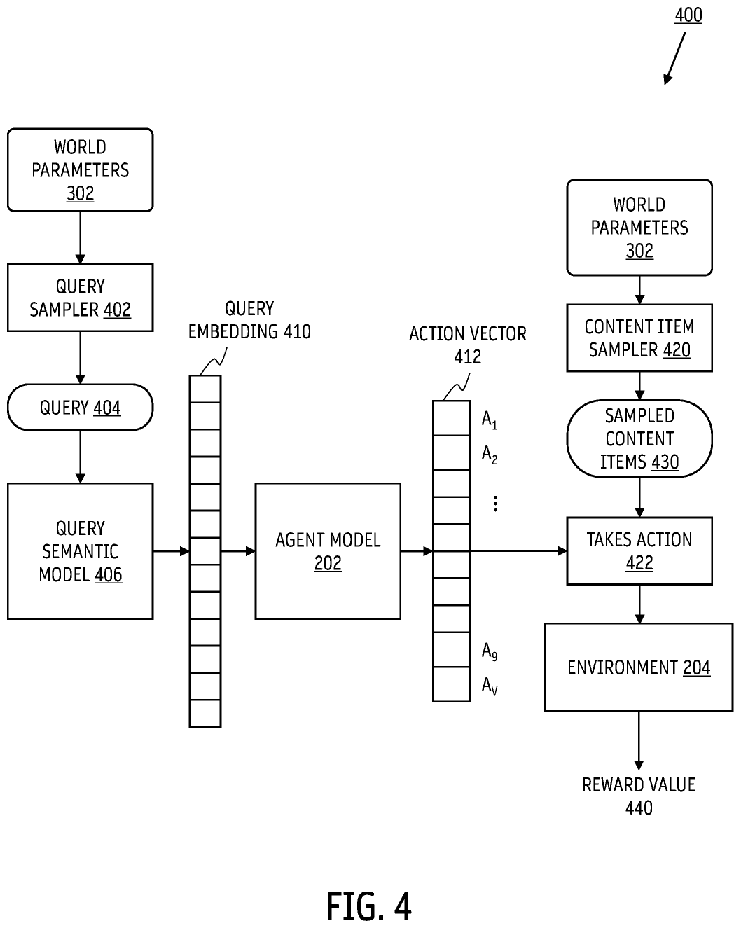

FIG. 4 illustrates exemplary agent model flow 400, according to some embodiments of the disclosure. Exemplary agent model flow 400 illustrates query sampling and content item sampling in a round. Exemplary agent model flow 400 illustrates agent model 202 taking an action in the round. Query sampler 402 may randomly sample or select query 404 from world parameters 302. The query 404 may be the basis of a round, simulating a random query being made by a simulated user. Content item sampler 420 may randomly sample or select a set of T number of sampled content items 430 from world parameters 302 that are associated with query 404. A simulated search may be generated by sampling T number of content items from query cluster data (e.g., query cluster data 308 of FIG. 3) for a query. T sampled content items may include P number of positive content items and N number of negative content items. Specifically, the T number of sampled content items 430 may include a P number of positive content items and an N number of negative content items. T=P+N. T equals to a sum of P and N. P and N may be fixed for all rounds being played by the agent model 202. A ratio of P:N may be 1:3. A ratio of P:N may be 1:4. Preferably, N is greater than P. P may be 2, and N may be 8. Having more negative content items than positive items may improve the agent model's ability to learn from the result of taking an action in a round. The T number of sampled content items 430 may be presented to agent model 202.

In some embodiments, exemplary agent model flow 400 may be used for context sampling and content item sampling in a round. Query sampler 402 may be replaced by and/or supplemented with a context sampler to randomly sample or select a context from world parameters 302. The context sampled by the context sampler may be the basis of a round, simulating a random context input by a simulated user. The context may include a query and one or more contextual factors. Content item sampler 420 may randomly sample or select a set of T number of sampled content items 430 from world parameters 302 that are associated with the context.

Sampled content items 430 may each have a corresponding reward value. A reward value may indicate a learning value or weight for a given content item or indicate how strong a signal given by a content item is when the agent model 202 learns from the round. Positive content items may have a positive reward value. Negative content items may have a negative reward value. Absolute values of reward or learning values of different content items may differ based on the strength of the signal given by the content item.

In the round, query 404 is input into a query semantic model 406. A query semantic model may transform query 404 into a query embedding 410 (e.g., a query state). Query embedding 410 may be input into agent model 202. In some embodiments, in the round, a context (sampled by a context sampler from world parameters 302) may be input into a context model. The context model may transform the context into a context embedding (e.g., a context state).

Agent model 202 may output an action vector 412. An action vector 412 may include one or more features A₁, A₂, . . . , and A_{V}. The V number of features of action vector 412 may correspond to V number of content item features in a content item feature vector. The one or more features of action vector 412 may be used to determine N's to be used in retrieving content items using different retrieval strategies (as illustrated in FIGS. 1 and 2B). When the agent model 202 is used to optimize N's, the N's may be different functions of the one or more features in the action vector 412. The features in action vector 412 may represent weights which relate to or are given to the description of content items, metadata of content items, or past engagement statistics of content items for different retrieval strategies.

In some embodiments, action vector 412 may include V number of features that represent and/or describe how much weight should be given to each retrieval strategy. Action vector 412 may be a feature representation of the weights to be given to each retrieval strategy. Action vector 412 may represent the different retrieval strategies and their connection to the content item features in the content item feature vector. Action vector 412 may be input into a model that can decode action vector 412 and obtain the N's for the different retrieval strategies. Utilizing a feature representation of the weights as opposed to the weights directly in action vector 412 can allow the system to incorporate new retrieval strategies or remove retrieval strategies (e.g., changing the number of retrieval strategies) without having to modify the dimensionality of action vector 412 and content item feature vectors. Action vector 412 may implicitly give different weights and/or contributions to different retrieval strategies for different features in the content item feature vector. Action vector 412 may explicitly give different weights and/or contributions to different retrieval strategies for different features in the content item feature vector.

The agent model 202 may produce action vector 412 that may assign different weights or contributions to different content item features. The agent model 202 may assign different weights to different content item features based on the observed state, e.g., the query 404 or the query embedding 410. In some embodiments, the agent model 202 may assign different weights to different content item features based on the observed state, e.g., the context, or the context embedding. Given a query “horror movies”, the agent model 202 may give more weight to the content item feature associated with past engagement statistics. Given a query “classic monster movies”, the agent model 202 may give more weight to the feature associated with semantic relevance/affinity. Given a context with query “scary movies” and seasonality being “Halloween”, the agent model 202 may give more weight give more weight to the content item feature associated with past engagement statistics. Given a context with query “fashion shows”, the agent model 202 may give more weight to a content item feature associated with user demographic and interests. Given a context with query “DIY projects”, the agent model 202 may give more weight to a content item feature associated with user demographic and interests.

Agent model 202 may take an action 422 on sampled content items 430 using the action vector 412. Using action vector 412, agent model 202 may determine scores for the sampled content items 430. Agent model 202 may determine from environment 204 content item feature vectors for the sampled content items 430. Agent model 202 may scale or multiply a content item feature in a content item feature vector for each content item in sampled content item 430 with the feature in action vector 412 corresponding to the content item feature. Agent model 202 may determine a dot product of the action vector 412 with a content item feature vector for each content item in sampled content item 430. Agent model 202 may arrange the sampled content items 430 based on the dot products (e.g., from high to low).

Agent model 202 may return top Q scored content items to environment 204. Environment 204 may evaluate the returned content items and provide reward feedback to agent model 202. The agent model 202 may update its policy (and parameters) to optimize for a higher reward.

Agent model 202 may determine and/or compute a round-level reward value 440 based on top Q number of sampled content items 430 having highest dot products. In some embodiments, round-level reward value 440 may be determined or modeled based on one or more factors about the returned items. The one or more factors about the returned items may indicate how well or how poorly the agent performed using the action vector.

In some cases, the round-level reward value 440 may include precision. Precision may be based on a positive rate of the returned content items (e.g., out of the Q number of returned content items, how many of the returned content items are positive content items). Computing precision may include determining a proportion of positive content items in the top Q number of content items having highest dot products.

In some cases, round-level reward value 440 may include recall. Recall may be based on a proportion of positive content items in the T number of sampled content items being in the Q number of returned items. Computing recall may include determining a number of positive content items in the top Q number of content items having highest dot products relative to a total number of positive content items in the T number of sampled content items.

In some cases, round-level reward value 440 may include discounted cumulative gain, measuring ranking quality of the positive content items in the sorted/arranged content items in 512. In some cases, measuring ranking quality of the positive content items in the sorted/arranged top Q number of content items in 514. High/good ranking quality may mean that positive content items are in top positions in the sorted/arranged content items ranking content items from having highest dot product to the lowest dot product. Poor/bad ranking quality may mean that negative content items are in top positions in the sorted/arranged content items ranking content items from having highest dot product to the lowest dot product. Discounted cumulative gain may be calculated based on position of the positive content items in the sorted/arranged content items in 512. Position of content items in the sorted/arranged content items may start from 1 to T (1 being a top position and T being a bottom position). Discounted cumulative gain may be calculated based on a sum of 1/position_of_positive_content_item for each positive content item in the top Q number of sampled content items having the highest dot products. 1/position_of_positive_content_item may be referred to as reciprocal rank of a positive content item. Discounted cumulative gain may be higher when positive content items are in the top positions than when the positive content items are in the bottom positions. Computing discounted cumulative gain may include determining a sum of reciprocal rank(s) of positive content item(s) in the top Q number of content items having the highest dot products.

In some cases, round-level reward value 440 may include a key reciprocal rank, which can include determining a reciprocal rank of a first/top positive content item in the top Q number of sampled content items having the highest dot products. The first/top positive content item may be a positive content item having a highest dot product in the top Q number of sampled content items. If the first/top positive content item is in a top position in the top Q number of sampled content items, the key reciprocal rank is 1/1=1. If the first/top positive content item is in a second position in the top Q number of sampled content items, the key reciprocal rank is ½. If the first/top positive content item is in a third position in the top Q number of sampled content items, the key reciprocal rank is ⅓. If there are no positive content items in the top Q number of sampled content items, the key reciprocal rank is 0.

In some cases, round-level reward value 440 may include regret value, which measures what a particular round could have gotten as the maximum (possible) reward value. Regret value may be the maximum reward value of the round subtracted by the reward value of the round (e.g., calculated based on one or more of precision, recall, discounted cumulative gain, mean reciprocal rank, etc.). Computing regret may include subtracting a maximum possible reward value of the top Q number of content items having the highest dot products by a reward value of the top Q number of content items having the highest dot products.

In some cases, round-level reward value 440 may include a sum of individual reward values associated with the top Q number of content items in 514. Positive content items may have corresponding positive reward values. Negative content items may have corresponding negative reward values.

In some cases, round-level reward value 440 may include a combination of values, such as precision, recall, discounted cumulative gain, mean reciprocal rank, and regret value. The combination may include a weighted combination of values. The combination may include a non-linear combination of values.

In some cases, round-level reward value 440 may be scaled or adjusted to ensure that round-level reward value 440 impacts the training of agent model appropriately. In some cases, there may not be many content items linked to a query or a context in the environment. The query or context may be rare or unpopular. Round-level reward value 440 may be scaled to increase round-level reward value 440 if round-level reward value 440 is high. Round-level reward value 440 may be scaled to decrease round-level reward value 440 if round-level reward value 440 is low. In some cases, there may be many content items linked to a query or a context in the environment. The query or context may be popular. Round-level reward value 440 may be scaled to decrease round-level reward value 440 if the query is popular to ensure the agent model does not get biased by the popularity of the query or context. Round-level reward value 440 may be scaled to increase round-level reward value 440 if the query is unpopular to ensure the agent model does not get biased by the popularity of the query or context.

In some cases, round-level reward value 440 may be scaled or adjusted to ensure that round-level reward value 440 influences the training of agent model in a certain way. Round-level reward value 440 may be scaled to increase round-level reward value 440 if content items in the top Q number of content items in 514 have a high proportion of revenue generating items, or are associated with high revenue generation. Round-level reward value 440 may be scaled to decrease round-level reward value 440 if content items in the top Q number of content items in 514 have a low proportion of revenue generating items, or are associated with low to little revenue generation.

To simulate multiple searches over time, searches may be simulated in the manner illustrated in FIG. 4 for a number of times to complete an episode. E number of rounds may be played in an episode. E may be 10. In some cases, an episode may end before E number of rounds have been completed, if the reward value(s) of the completed round(s) do not meet a criterion for continuing the episode. For instance, a criterion may include using a trust value which can be based on reward value(s) of completed round(s). The trust value after completing a round in an episode may increase if the reward of the completed round is positive. The trust value after completing a round in an episode may decrease if the reward of the completed is negative. If the trust value falls below a threshold, the criterion for continuing the episode is not met and the episode may end early. If the trust value is above the threshold, the criterion for continuing the episode is met. In some cases, if the trust value is increasing or staying the same, the criterion for continuing the episode is met, and the episode may continue. If the trust value is decreasing, the criterion for continuing the episode is not met, and the episode may end early. For a given round in an episode, the reward value may be determined based on the reward value of the current round and reward values of one or more future rounds in the same episode.

### Exemplary Method for Playing a Round in an Episode

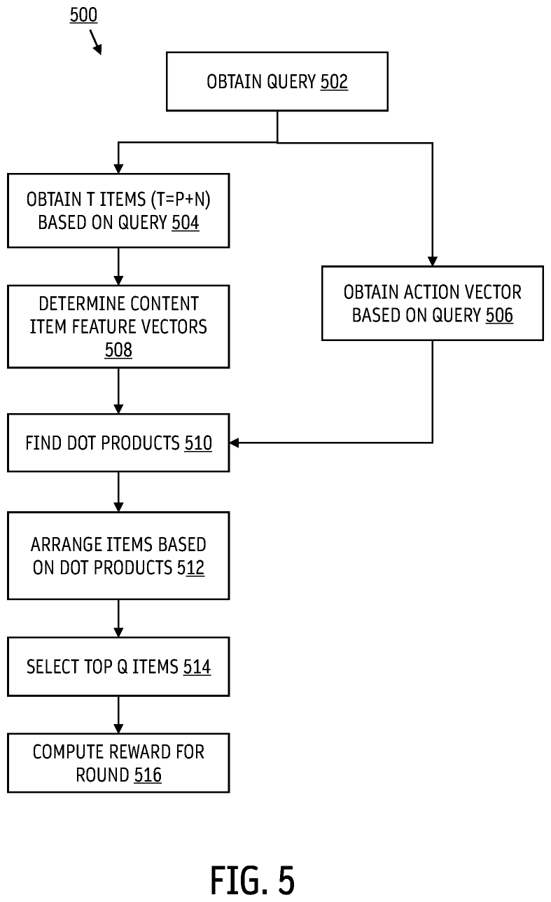

FIG. 5 is a flow chart illustrating operations (of method 500) performed in a round of an episode, according to some embodiments of the disclosure.

In 502, a query may be obtained (e.g., randomly sampled as illustrated in FIG. 4). In some embodiments, a context may be obtained (e.g., randomly sampled as illustrated in FIG. 4).

In 506, an action vector may be obtained using the agent model based on the query obtained in 502. In some embodiments, an action vector may be obtained using the agent model based on the context obtained in 502.

In 504, T number of content items may be obtained (e.g., randomly sampled as illustrated in FIG. 4).

In 508, content item feature vectors may be determined for the content items (e.g., from the environment).

In 510, a dot product of a content item feature vector and the action vector in 506 may be determined for each content items obtained in 504.

In 512, the content items may be arranged (e.g., sorted, ordered, ranked, etc.) based on the dot products corresponding to the content items.

In 514, top Q items may be selected from the arranged content items (e.g., top Q items having the highest dot products).

In 516, a reward value for the round can be computed based on the top Q items in 514.

Depending on the number of rounds already played in an episode, the operations of method 500 may be repeated for one or more additional rounds in an episode.

### Exemplary Methods for Implementing the Agent Model

In some embodiments, the agent model may include a (deep) neural network comprising two or more neural network layers. A neural network layer may include neurons. A neuron may receive one or more inputs and implement an activation function on the inputs to generate one or more outputs. Parameters of the activation function of the neurons may be trained, learned, or updated based on observations that the agent model has made. The parameters may correspond to the policy or strategy being used by the agent model to produce the action vector.

The observations may include round-level reward values of the rounds played by the agent model. The observations may include expected long-term reward values of the rounds in an episode played by the agent model. The parameters may be updated to optimize and/or maximize the reward values. The parameters may be updated using soft actor critic (SAC).

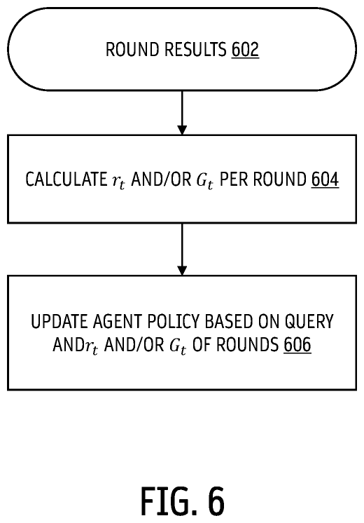

FIG. 6 is a flowchart illustrating operations for training and/or updating an agent model using round results, according to some embodiments of the disclosure. Round results 602 may be collected for many rounds and many episodes. A result of a round may include the query in the round, the action vector generated for the query in the round, the reward value for the round. In some embodiments, a result of a round may include the context in the round, the action vector generated for the context in the round, the reward value for the round.

In 604, a round-level reward rₜ and/or an expected long-term rewards Gₜ may be computed, based on the reward value for the present round and one or more future/subsequent rounds of a given episode.

In 606, a policy (e.g., strategy, parameters) of the agent model may be updated based on the query and round-level reward rₜ and/or the expected long-term rewards Gₜ of the rounds. In some embodiments, a policy (e.g., strategy, parameters) of the agent model may be updated based on the context and round-level reward rₜ and/or the expected long-term rewards Gₜ of the rounds.

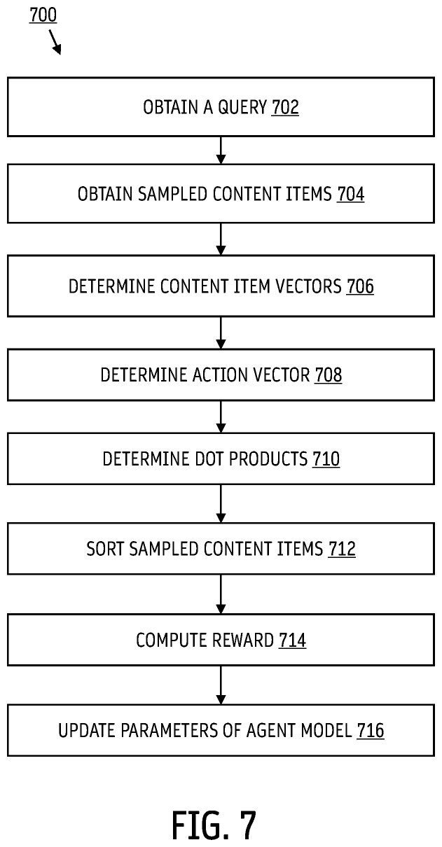

FIG. 7 is a flowchart showing a method 700 for training and/or updating parameters of an agent model, according to some embodiments of the disclosure.

In 702, a query may be obtained (e.g., randomly selected from the environment or world parameters). In some embodiments, a context may be obtained (e.g., randomly selected from environment or world parameters).

In 704, a number of sampled content items may be obtained (e.g., randomly selected from selected from the environment or world parameters) from content items corresponding to the query. In some embodiments, a number of sampled content items may be obtained (e.g., randomly selected from selected from the environment or world parameters) from content items corresponding to the context. The sampled content items may include positive content items and negative content items.

In 706, content item feature vectors corresponding to the sampled content items may be determined, e.g., using a suitable model. A content item feature vector can be generated based on one or more of: a description of a sampled content item, metadata of the sampled content item, past engagement statistics of the sampled content item, and a retrieval strategy used to retrieve the sampled content item.

In 708, using parameters of an agent model and an embedding of the query, an action vector may be determined. In some embodiments, using parameters of an agent model and an embedding of the context, an action vector may be determined. The action vector can include weights corresponding to elements in the content item feature vector.

In 710, for each sampled content item, a dot product of the action vector and the content item feature vector may be determined. Sampled content items may have corresponding dot products.

In 712, the sampled content items may be sorted or arranged based on dot products.

In 714, a reward or reward value may be computed based on a top Q number of content items having highest dot products.

In 716, the parameters of the agent model may be updated based on the query, the action vector, and the reward. In some embodiments, the parameters of the agent model may be updated based on the context, the action vector, and the reward.

### Exemplary Computing Device

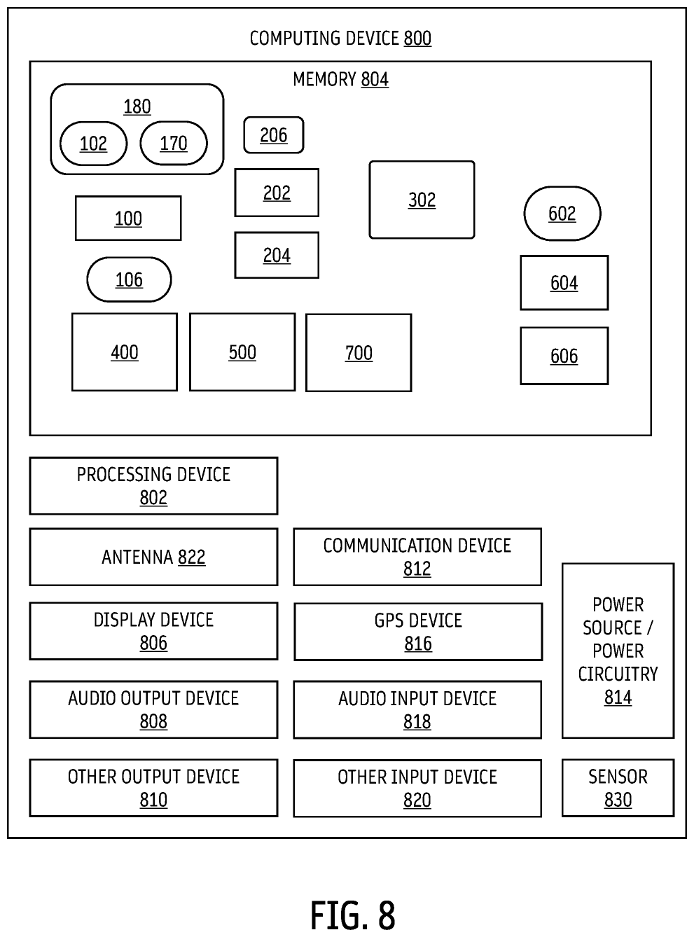

FIG. 8 is a block diagram of an exemplary computing device 800, according to some embodiments of the disclosure. One or more computing devices 800 may be used to implement the functionalities described with the FIGS. and herein. A number of components are illustrated in the FIGS. as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, and the computing device 800 may include interface circuitry for coupling to the one or more components. For example, the computing device 800 may not include a display device 806, and may include display device interface circuitry (e.g., a connector and driver circuitry) to which a display device 806 may be coupled. In another set of examples, the computing device 800 may not include an audio input device 818 or an audio output device 808 and may include audio input or output device interface circuitry (e.g., connectors and supporting circuitry) to which an audio input device 818 or audio output device 808 may be coupled.

The computing device 800 may include a processing device 802 (e.g., one or more processing devices, one or more of the same type of processing device, one or more of different types of processing device). The processing device 802 may include electronic circuitry that process electronic data from data storage elements (e.g., registers, memory, resistors, capacitors, quantum bit cells) to transform that electronic data into other electronic data that may be stored in registers and/or memory. Examples of processing device 802 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 800 may include a memory 804, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 804 includes one or more non-transitory computer-readable storage media. In some embodiments, memory 804 may include memory that shares a die with the processing device 802. In some embodiments, memory 804 includes one or more non-transitory computer-readable media storing instructions executable to perform operations described with the FIGS. and herein, such as the methods illustrated in FIGS. 1, 2A-B, and 4-7. Exemplary parts that may be encoded as instructions and stored in memory 804 are depicted. Memory 804 may store instructions that encode one or more exemplary parts. The instructions stored in the one or more non-transitory computer-readable media may be executed by processing device 802. In some embodiments, memory 804 may store data, e.g., data structures, binary data, bits, metadata, files, blobs, etc., as described with the FIGS. and herein. Exemplary data that may be stored in memory 804 are depicted. Memory 804 may store one or more data as depicted.

In some embodiments, the computing device 800 may include a communication device 812 (e.g., one or more communication devices). For example, the communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 812 may operate in accordance with other wireless protocols in other embodiments. The computing device 800 may include an antenna 822 to facilitate wireless communications and/or to receive other wireless communications (such as radio frequency transmissions). The computing device 800 may include receiver circuits and/or transmitter circuits. In some embodiments, the communication device 812 may manage wired communications, such as electrical, optical, or any other suitable communication protocols (e.g., the Ethernet). As noted above, the communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

The computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include a sensor 830 (or one or more sensors). The computing device 800 may include corresponding interface circuitry, as discussed above). Sensor 830 may sense physical phenomenon and translate the physical phenomenon into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 800 may be any other electronic device that processes data.

### Select Examples

Example 1 provides a method, including obtaining a query; obtaining, from content items corresponding to the query, a number of sampled content items; determining content item feature vectors corresponding to the sampled content items, where a content item feature vector is generated based on a description of a sampled content item, metadata of the sampled content item, one or more past engagement statistics of the sampled content item, and a retrieval strategy used to retrieve the sampled content item; determining, using parameters of an agent model and an embedding of the query, an action vector including features corresponding to elements in the content item feature vector, and the action vector is a feature representation of weights given to different retrieval strategies; for each sampled content item, determining a dot product of the action vector and the content item feature vector; sorting the sampled content items based on dot products; computing a reward based on a top number of sampled content items having highest dot products; and updating the parameters of the agent model based on the query, the action vector, and the reward.

Example 2 provides the method of example 1, where obtaining the query includes randomly sampling from historical logs of user activity on a content platform.

Example 3 provides the method of example 1 or 2, where obtaining the number of sampled content items includes randomly sampling a first number of positive content items and a second number of positive content items associated with the query using historical logs of user activity on a content platform.

Example 4 provides the method of any one of examples 1-3, where computing the reward includes determining a proportion of positive content items in the top number of the content items having the highest dot products.

Example 5 provides the method of any one of examples 1-4, where computing the reward includes determining a number of positive content items in the top number of the content items having the highest dot products relative to a total number of positive content items in the number of sampled content items.

Example 6 provides the method of any one of examples 1-5, where computing the reward includes determining a sum of reciprocal rank(s) of positive content item(s) in the top number of content items having the highest dot products.

Example 7 provides the method of any one of examples 1-6, where computing the reward includes determining a key reciprocal rank of a top positive content item having a highest dot product in the top number of content items having the highest dot products.

Example 8 provides the method of any one of examples 1-7, where computing the reward includes subtracting a maximum possible reward value of the top number of content items having the highest dot products by a reward value of the top number of content items having the highest dot products.

Example 9 provides one or more non-transitory computer-readable media having instructions stored thereon, when the instructions are executed by one or more processors, cause the one or more processors to: obtain a query; obtain, from content items corresponding to the query, a number of sampled content items; determine content item feature vectors corresponding to the sampled content items, where a content item feature vector is generated based on a description of a sampled content item, metadata of the sampled content item, one or more past engagement statistics of the sampled content item, and a retrieval strategy used to retrieve the sampled content item; determine, using parameters of an agent model and an embedding of the query, an action vector including features corresponding to elements in the content item feature vector, and the action vector is a feature representation of weights given to different retrieval strategies; for each sampled content item, determine a dot product of the action vector and the content item feature vector; sort the sampled content items based on dot products; compute a reward based on a top number of sampled content items having highest dot products; and update the parameters of the agent model based on the query, the action vector, and the reward.

Example 10 provides the one or more non-transitory computer-readable media of example 9, where obtaining the query includes randomly sampling from historical logs of user activity on a content platform.

Example 11 provides the one or more non-transitory computer-readable media of example 9 or 10, where obtaining the number of sampled content items includes randomly sampling a first number of positive content items and a second number of positive content items associated with the query using historical logs of user activity on a content platform.

Example 12 provides the one or more non-transitory computer-readable media of any one of examples 9-11, where computing the reward includes determining a proportion of positive content items in the top number of the content items having the highest dot products.

Example 13 provides the one or more non-transitory computer-readable media of any one of examples 9-12, where computing the reward includes determining a number of positive content items in the top number of the content items having the highest dot products relative to a total number of positive content items in the number of sampled content items.

Example 14 provides the one or more non-transitory computer-readable media of any one of examples 9-13, where computing the reward includes determining a sum of reciprocal rank(s) of positive content item(s) in the top number of content items having the highest dot products.

Example 15 provides the one or more non-transitory computer-readable media of any one of examples 9-14, where computing the reward includes determining a key reciprocal rank of a top positive content item having a highest dot product in the top number of content items having the highest dot products.

Example 16 provides the one or more non-transitory computer-readable media of any one of examples 9-15, where computing the reward includes subtracting a maximum possible reward value of the top number of content items having the highest dot products by a reward value of the top number of content items having the highest dot products.

Example 17 provides a method, including obtaining a context; obtaining, from content items corresponding to the context, a number of sampled content items; determining content item feature vectors corresponding to the sampled content items, where a content item feature vector is generated based on a description of a sampled content item, metadata of the sampled content item, one or more past engagement statistics of the sampled content item, and a retrieval strategy used to retrieve the sampled content item; determining, using parameters of an agent model and an embedding of the context, an action vector including features corresponding to elements in the content item feature vector, and the action vector is a feature representation of weights given to different retrieval strategies; for each sampled content item, determining a dot product of the action vector and the content item feature vector; sorting the sampled content items based on dot products; computing a reward based on a top number of content items having highest dot products; and updating the parameters of the agent model based on the context, the action vector, and the reward.

Example 18 provides the method of example 17, where obtaining the context includes randomly sampling from historical logs of user activity on a content platform.

Example 19 provides the method of example 17 or 18, where obtaining the number of sampled content items includes randomly sampling a first number of positive content items and a second number of positive content items associated with the context using historical logs of user activity on a content platform.

Example 20 provides the method of any one of examples 17-19, where computing the reward includes determining a proportion of positive content items in the top number of the content items having the highest dot products.

Example 21 provides the method of any one of examples 17-20, where computing the reward includes determining a number of positive content items in the top number of the content items having the highest dot products relative to a total number of positive content items in the number of sampled content items.

Example 22 provides the method of any one of examples 17-21, where computing the reward includes determining a sum of reciprocal rank(s) of positive content item(s) in the top number of content items having the highest dot products.

Example 23 provides the method of any one of examples 17-22, where computing the reward includes determining a key reciprocal rank of a top positive content item having a highest dot product in the top number of content items having the highest dot products.

Example 24 provides the method of any one of examples 17-23, where computing the reward includes subtracting a maximum possible reward value of the top number of content items having the highest dot products by a reward value of the top number of content items having the highest dot products.

Example A provides one or more non-transitory computer-readable media storing instructions that, when executed by one or more processors, cause the one or more processors to perform any one of the methods provided in examples 1-8 and 17-24.

Example B provides an apparatus comprising means to carry out or means for carrying out any one of the computer-implemented methods provided in examples 1-8 and 17-24.

Example C provides a computer-implemented system, comprising one or more processors, and one or more non-transitory computer-readable media storing instructions that, when executed by the one or more processors, cause the one or more processors to perform any one of the methods provided in examples 1-8 and 17-24.

Example D provides a computer-implemented system comprising one or more components illustrated in FIG. 4 to perform operations described herein.

### VARIATIONS AND OTHER NOTES

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
obtaining a query;
obtaining, from content items corresponding to the query, a number of sampled content items;
determining content item feature vectors corresponding to the sampled content items, wherein a content item feature vector is generated based on a description of a sampled content item, metadata of the sampled content item, one or more past engagement statistics of the sampled content item, and a retrieval strategy used to retrieve the sampled content item;
determining, using parameters of an agent model and an embedding of the query, an action vector comprising features corresponding to elements in the content item feature vector, and the action vector is a feature representation of weights given to different retrieval strategies;
for each sampled content item, determining a dot product of the action vector and the content item feature vector;
sorting the sampled content items based on dot products;
computing a reward based on a top number of sampled content items having highest dot products; and
updating the parameters of the agent model based on the query, the action vector, and the reward.

2. The method of claim 1, wherein obtaining the query comprises randomly sampling from historical logs of user activity on a content platform.

3. The method of claim 1, wherein obtaining the number of sampled content items comprises randomly sampling a first number of positive content items and a second number of positive content items associated with the query using historical logs of user activity on a content platform.

4. The method of claim 1, wherein computing the reward comprises:
determining a proportion of positive content items in the top number of the content items having the highest dot products.

5. The method of claim 1, wherein computing the reward comprises:
determining a number of positive content items in the top number of the content items having the highest dot products relative to a total number of positive content items in the number of sampled content items.

6. The method of claim 1, wherein computing the reward comprises:
determining a sum of reciprocal rank(s) of positive content item(s) in the top number of content items having the highest dot products.

7. The method of claim 1, wherein computing the reward comprises:
determining a key reciprocal rank of a top positive content item having a highest dot product in the top number of content items having the highest dot products.

8. The method of claim 1, wherein computing the reward comprises:
subtracting a maximum possible reward value of the top number of content items having the highest dot products by a reward value of the top number of content items having the highest dot products.

9. One or more non-transitory computer-readable media having instructions stored thereon, when the instructions are executed by one or more processors, cause the one or more processors to:
obtain a query;
obtain, from content items corresponding to the query, a number of sampled content items;
determine content item feature vectors corresponding to the sampled content items, wherein a content item feature vector is generated based on a description of a sampled content item, metadata of the sampled content item, one or more past engagement statistics of the sampled content item, and a retrieval strategy used to retrieve the sampled content item;
determine, using parameters of an agent model and an embedding of the query, an action vector comprising features corresponding to elements in the content item feature vector, and the action vector is a feature representation of weights given to different retrieval strategies;
for each sampled content item, determine a dot product of the action vector and the content item feature vector;
sort the sampled content items based on dot products;
compute a reward based on a top number of sampled content items having highest dot products; and
update the parameters of the agent model based on the query, the action vector, and the reward.

10. The one or more non-transitory computer-readable media of claim 9, wherein obtaining the query comprises randomly sampling from historical logs of user activity on a content platform.

11. The one or more non-transitory computer-readable media of claim 9, wherein obtaining the number of sampled content items comprises randomly sampling a first number of positive content items and a second number of positive content items associated with the query using historical logs of user activity on a content platform.

12. The one or more non-transitory computer-readable media of claim 9, wherein computing the reward comprises:
determining a proportion of positive content items in the top number of the content items having the highest dot products.

13. The one or more non-transitory computer-readable media of claim 9, wherein computing the reward comprises:
determining a number of positive content items in the top number of the content items having the highest dot products relative to a total number of positive content items in the number of sampled content items.

14. The one or more non-transitory computer-readable media of claim 9, wherein computing the reward comprises:
determining a sum of reciprocal rank(s) of positive content item(s) in the top number of content items having the highest dot products.

15. The one or more non-transitory computer-readable media of claim 9, wherein computing the reward comprises:
determining a key reciprocal rank of a top positive content item having a highest dot product in the top number of content items having the highest dot products.

16. The one or more non-transitory computer-readable media of claim 9, wherein computing the reward comprises:
subtracting a maximum possible reward value of the top number of content items having the highest dot products by a reward value of the top number of content items having the highest dot products.

17. A method, comprising:
obtaining a context;
obtaining, from content items corresponding to the context, a number of sampled content items;
determining content item feature vectors corresponding to the sampled content items, wherein a content item feature vector is generated based on a description of a sampled content item, metadata of the sampled content item, one or more past engagement statistics of the sampled content item, and a retrieval strategy used to retrieve the sampled content item;
determining, using parameters of an agent model and an embedding of the context, an action vector comprising features corresponding to elements in the content item feature vector, and the action vector is a feature representation of weights given to different retrieval strategies;
for each sampled content item, determining a dot product of the action vector and the content item feature vector;
sorting the sampled content items based on dot products;
computing a reward based on a top number of content items having highest dot products; and
updating the parameters of the agent model based on the context, the action vector, and the reward.

18. The method of claim 17, wherein computing the reward comprises:
determining a sum of reciprocal rank(s) of positive content item(s) in the top number of content items having the highest dot products.

19. The method of claim 17, wherein computing the reward comprises:
determining a key reciprocal rank of a top positive content item having a highest dot product in the top number of content items having the highest dot products.

20. The method of claim 17, wherein computing the reward comprises:
subtracting a maximum possible reward value of the top number of content items having the highest dot products by a reward value of the top number of content items having the highest dot products.
